(19) United States
(12) Patent Application Publication
(10) Pub. No.: US 2012/0053967 A1
(43) Pub. Date: Mar. 1, 2012

(54) System and Method for Account Reconciliation

(75) Inventors: John R. Roberts, Heathfield (GB); Karen M. Denardo, New York, NY (US); Edward T. Orrell, Brighton (GB)

(73) Assignee: American Express Travel Related Services Company, Inc., New York, NY (US)

(21) Appl. No.: 12/873,975

(22) Filed: Sep. 1, 2010

(51) Int. Cl. G06Q 10/00

(52) U.S. Cl. 705/5

(57) ABSTRACT

A travel management system is configured to facilitate the resolution of issues related to transaction posted to a transaction account. The travel management system provides a communication portal that allows a transaction account owner to communicate efficiently with a transaction account provider and a travel service provider or other merchant to quickly resolve issue related to particular transactions. The system allows payment deadlines for transactions with associated issues to be suspended while the issues are resolved. Moreover, the system allows user and transaction account providers to evaluate the issue resolution performance of travel service providers and other merchants.

### FIELD OF INVENTION

The present disclosure generally relates to the management of transactions, and more particularly, to a method and system for tracking and reconciling travel expenses of various travelers that are posted to a single transaction account.

### BACKGROUND OF THE INVENTION

Business travelers usually have their business travel expenses paid by their employers. The accounting departments responsible for paying those expenses generally require proof of a purchase for most of those expenses. This requirement can create a problem for the business traveler and the accounting department where the proof of purchase is lost.

Further, resolving issues related to discrepancies between transactions and proofs of purchase has often been a manual, time intensive and in-efficient process. This process is made more difficult where the transaction account owner is required to communicate with the transaction account provider and the merchant separately.

### SUMMARY OF THE INVENTION

Systems and methods for managing travel transactions are provided. In an embodiment, the system is configured to receive a request to resolve an issue related to a transaction. The system may change the status of the transaction associated with the request such that the payment deadline associated with the transaction is suspended until the issue is resolved. The system can determine which of the transaction account provider and/or the travel management company is responsible for satisfying the issue based on information provided in the request (e.g., an issue identifier, comments provided by a user, and the like). The request to resolve the issue may then be transmitted to the transaction account provider or the travel management company. Based on system preferences or rules, the request to resolve the issue may be provided to the transaction account provider to insure that the account is properly maintained. The status of the request may be monitored to insure that the issue is resolved in accordance with predetermined rules established for efficient issue resolution. The system may receive resolution information associated with the request from the transaction account provider and/or the travel management company. The information may include that the transaction amount associated with the resolution information be modified. The receipt of resolution information may also trigger a change in the status of the transaction information, such that the payment deadline for the transaction is re-established.

In an embodiment, the system may be configured to rate or grade the performance of the transaction account provider or travel management company. The system may be configured to provide status updates to a user that initiated a request to resolve an issue related to a charge. Moreover, portions of the systems (e.g., a user interface) may be deployed or accessible through a mobile device.

### BRIEF DESCRIPTION OF THE DRAWINGS

A more complete understanding of the present inventions may be derived by referring to the detailed description and claims when considered in connection with the Figures, wherein like reference numbers refer to similar elements throughout the Figures, and:

FIG. 1A is a block diagram illustrating specific system components for managing travel related transactions, in accordance with an exemplary embodiment;

FIG. 1B is a block diagram illustrating major system components in a mobile environment for managing travel related transactions, in accordance with an exemplary embodiment;

FIG. 1C is a block diagram illustrating general system components for managing travel related transactions, in accordance with an exemplary embodiment; and

FIG. 2 is a flow chart illustrating an exemplary process for managing travel related transactions, in accordance with an exemplary embodiment.

### DETAILED DESCRIPTION

The detailed description of exemplary embodiments herein shows exemplary embodiments by way of illustration and its best mode. While these exemplary embodiments are described in sufficient detail to enable those skilled in the art to practice the invention, it should be understood that other embodiments may be realized and that logical, chemical and mechanical changes may be made without departing from the spirit and scope of the invention. Thus, the detailed description herein is presented for purposes of illustration only and not of limitation. For example, the steps recited in any of the method or process descriptions may be executed in any order and are not necessarily limited to the order presented. Moreover, many of the functions or steps may be outsourced to or performed by one or more third parties. Furthermore, any reference to singular includes plural embodiments, and any reference to more than one component or step may include a singular embodiment or step.

For the sake of brevity, conventional data networking, application development and other functional aspects of the systems (and components of the individual operating components of the systems) may not be described in detail herein.

In general, the systems and methods include a unique combination of one or more features associated with the tracking and managing transactions for expenses (e.g., travel expenses such as airfare, lodging expenses, transportation expenses, and the like) of various employees which are charged to a common employer transaction account. More specifically, a system and method is disclosed for identifying transactions of various employees which are charged to a common employer transaction account, and which require resolutions, tracking, reconciliation, and/or reporting. For example, the system and method may provide a unique online network that allows a user (e.g. an account owner and/or a representative of the account owner) to communicate securely with a travel management company (e.g. a travel agent, travel services website, travel services provider, etc.) and the transaction account issuer (e.g. American Express). The communication capabilities of the system may enhance every stage of the reconciliation process by increasing the visibility, ease of use, and efficiency. The system provides data online and enables the user to customize a view of the transaction data associated with the account to fit the needs of the user's task (e.g. resolutions, tracking, reconciliation, and/or reporting). The system may link the transaction data to a record of the transaction (e.g. an invoice, a receipt, proof of payment, etc.). The system may provide the capability of sending a request to the travel management company and/or transaction account issuer to resolve an issue.

Moreover, the system may provide accounting tools. These account tools enable users to understand, pay, and allocate purchases to the account owner's accounting system. The system provides account owners (that use a central account for business, travel, and travel related charges) with a single statement or a set of consolidated statements that reflects transactions and/or charges for various travelers. Because a common account may have transactions and/or charges for various travelers, the volume of transaction data may pose practical issues for resolution, tracking, reconciliation, and/or reporting. As such, the system provides the user with all the detail desired or needed for a transaction or charge. Moreover, system allows the transaction data to be arranged to satisfy the user's needs. By linking the transaction and the record of the transaction, the user may efficiently identify issues with particular transactions and send requests to the travel management company and/or to the transaction account issuer to resolve the issues before agreeing to pay the transactions and/or charges on the common account.

“User” as used herein may include any individual, customer, cardmember, employee, contractor, group, participant, beneficiary, account holder, account owner, recipient, charitable organization, software, hardware, and/or other entity that has an interest in a transaction account.

A “transaction account” as used herein refers to an account associated with an open account or a closed account system (as described below). The transaction account may exist in a physical or non-physical embodiment. For example, a transaction account may be distributed in non-physical embodiments such as an account number, frequent-flyer account, telephone calling account or the like. Furthermore, a physical embodiment of a transaction account may be distributed as a financial instrument (or card). The term “transaction instrument” is used herein to be synonymous with the term “transaction account,” unless indicated otherwise.

A “transaction account code,” “account,” “account number” or “account code,” as used herein, may include any device, code, number, letter, symbol, digital certificate, smart chip, digital signal, analog signal, biometric or other identifier/indicia suitably configured to allow a consumer to access, interact with or communicate with a financial transaction system. The account number may optionally be located on or associated with any financial transaction instrument (e.g., rewards, charge, credit, debit, prepaid, telephone, embossed, smart, magnetic stripe, bar code, transponder or radio frequency card).

A “transaction account provider” may include any entity that offers transaction account services to recipients. Although often referred to as a “financial institution,” the financial institution may represent any type of bank, brokerage, lender or other type of account issuing institution. It is further noted that other participants may be involved in some phases of the transaction, such as an intermediary settlement institution.

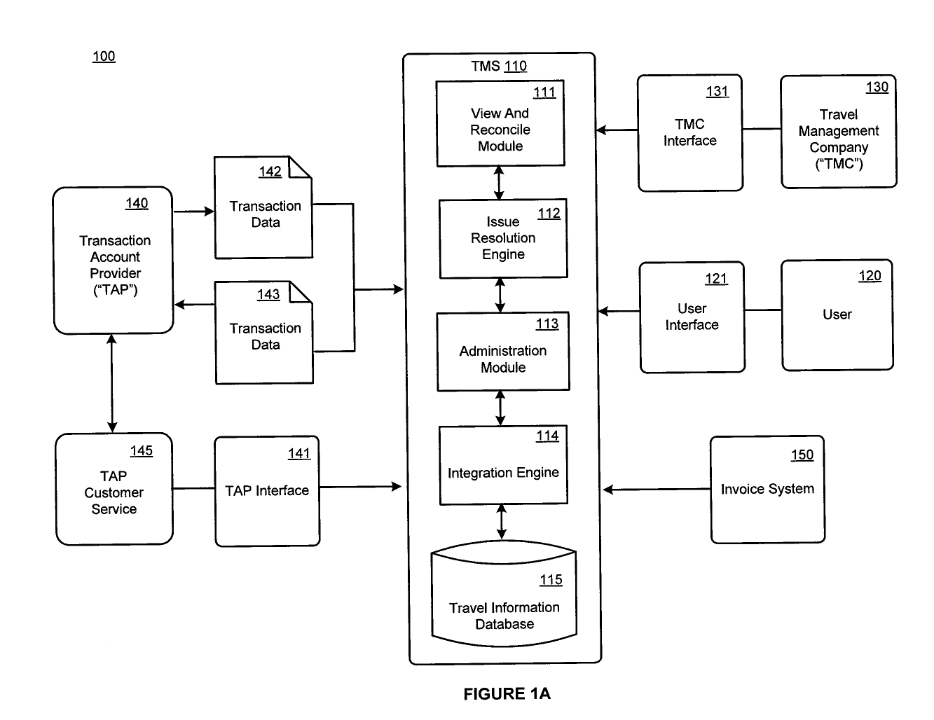

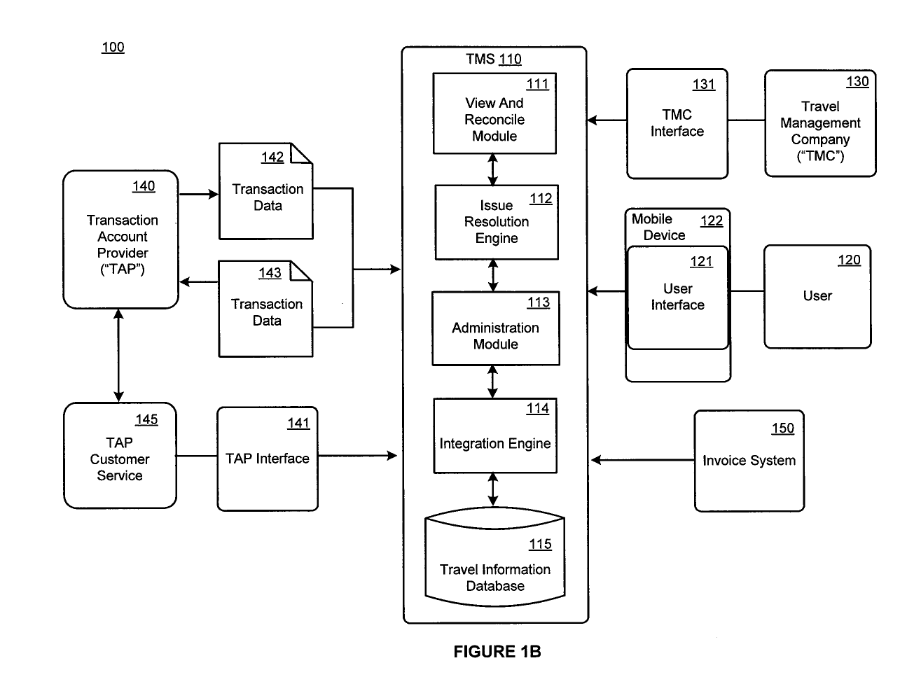

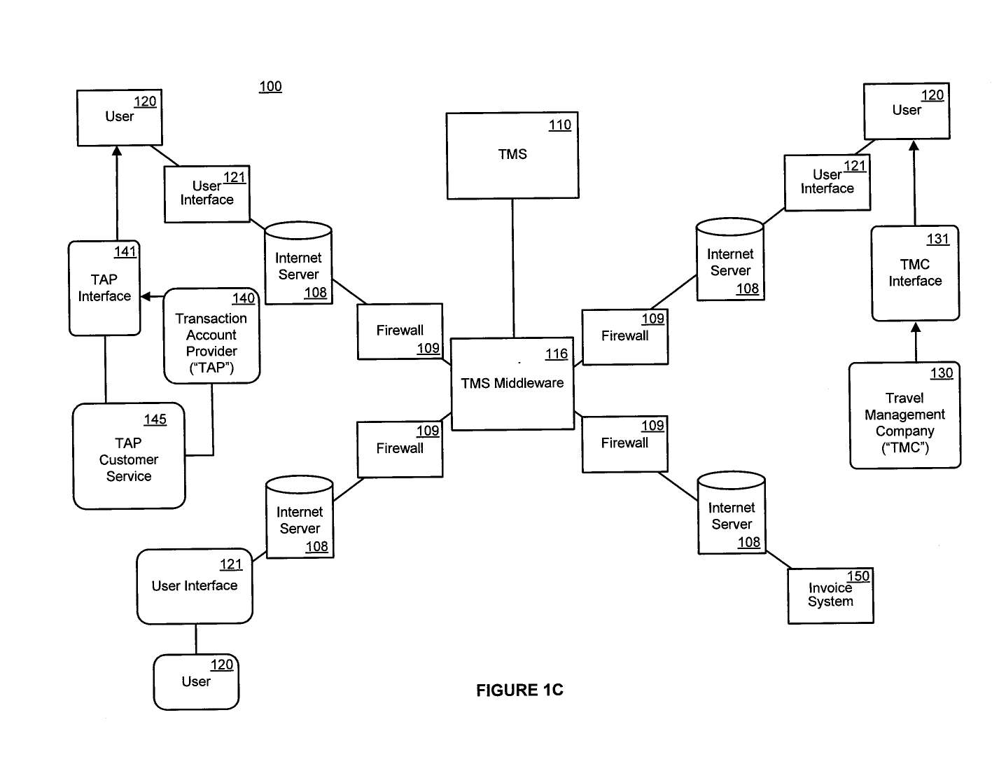

With reference to FIG. 1A, and in accordance with an embodiment, system 100 may be any system configured to track, manage, analyze, identify, reconcile, resolve, and/or store financial transactions associated with a transaction account. In an exemplary embodiment, system 100 comprises a Transaction Management System (“TMS”) 110 in communication with a user 120, and travel management company (“TMC”) 130 and/or a transaction account provider (“TAP”) 140. TMS 110 may be part of TAP 140 or provided separately from TAP 140. In an embodiment, TMS 110 may be provided with various interfaces including, for example, user interface 121 configured to provide user 120 with access to TMS 110, TMC interface 131 configured to provide TMC 130 with access TMS 110, and TAP interface 141 configured to provide TAP 140 with access TMS 110. It should be understood that each of user interface 121, TMC interface 131, and/or TAP interface 141 may be provided as separate portals or as a common portal which is configured to adapt its view of or access to information contained within TMS 110 based on the entity (e.g. user 120, TMC 130, or TAP 140) accessing the user interface 121, TMC interface 131, and/or TAP interface 141.

TMS 110 may comprise a view and reconcile module 111, an issue resolution engine 112, an administration module 113, an integration module 114, a database 115 and/or other sub-systems. Each of reconcile module 111, issue resolution engine 112, administration module 113, and integration module 114 may be configured to communicate and recall information from database 115. Other sub-systems may include, for example, reporting engines, management information systems, business information systems, third-party data providers and the like. Each of the sub-systems may be interconnected by a network via any method and/or device described herein.

User interface 121 may provide user 120 with access to (and communicate with) view and reconcile module 111, issue resolution engine 112, administration module 113, integration module 114, database 115 and/or various systems provided at TMS 110. TMC interface 131 may provide TMC 130 with access to and communication with the view and reconcile module 111, issue resolution engine 112, administration module 113, integration module 114, database 115 and/or various systems provided at TMS 110. TAP interface 141 may provide TAP 140 with access to (and communicate with) view and reconcile module 111, issue resolution engine 112, administration module 113, integration module 114, database 115 and/or various systems provided at TMS 110. Each of user interface 121, TMC interface 131, and TAP interface 141 may selectively provide access to view and reconcile module 111, issue resolution engine 112, administration module 113, integration module 114, database 115 and/or various systems provided at TMS 110. Moreover, access for user 120, TMC 130, and/or TAP 140 may be limited to various components of TMS 110. As such, in various embodiments, user interface 121, TMC interface 131, and TAP interface 141 may have access to at least one of view and reconcile module 111, issue resolution engine 112, administration module 113, integration module 114, database 115 and/or various systems provided at TMS 110 depending on the roles and responsibilities of each of user 120, TMC 130, and TAP 140.

User interface 121, TMC interface 131, and/or TAP interface 141 may each comprise any hardware and/or software suitably configured to facilitate requesting, retrieving, updating, analyzing, entering and/or modifying data. In an embodiment, user interface 121 is configured to facilitate input, receipt, reconciliation, communication and/or review of information relating to transactions posted to a common transaction account. User interface 121 includes any device (e.g., personal computer) which communicates (in any manner discussed herein) TMS 110 via any network discussed herein. Such browser applications comprise Internet browsing software installed within a computing unit or system to conduct online transactions and/or communications. These computing units or systems may take the form of a computer or set of computers, although other types of computing units or systems may be used, including laptops, notebooks, hand held computers, set-top boxes, workstations, computer-servers, main frame computers, mini-computers, PC servers, pervasive computers, network sets of computers, and/or the like. Practitioners will appreciate that user interface 121 may or may not be in direct contact with TMS 110. For example, user interface 121 may access the services of TMS 110 through another server, which may have a direct or indirect connection to the Internet.

As those skilled in the art will appreciate, User interface 121, TMC interface 131, and/or TAP interface 141 may each includes operating system (e.g., Windows NT, 95/98/2000/XP/Vista/7, OS2, UNIX, Linux, Solaris, MacOS, etc.) as well as various conventional support software and drivers typically associated with computers. User interface 121, TMC interface 131, and/or TAP interface 141 may each include any suitable personal computer, network computer, workstation, minicomputer, mainframe or the like. User interface 121, TMC interface 131, and/or TAP interface 141 may each may each be in a home or business environment with access to a network. In an exemplary embodiment, access is through a network or the Internet through a commercially available web-browser software package.

User interface 121, TMC interface 131, and/or TAP interface 141 may each may each be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., Gilbert Held, Understanding Data Communications (1996), which is hereby incorporated by reference. It is noted that the network may be implemented as other types of networks, such as an interactive television (ITV) network.

User interface 121, TMC interface 131, and/or TAP interface 141 may each include any number of applications, code modules, cookies, and/or the like to facilitate interaction with TMS 110 in order to for example, view statements, view transactions, view transaction information, submit/authorize a transactions, communicate, request resolution of an identified issue and the like. In one embodiment, user interface 121, TMC interface 131, and/or TAP interface 141 may each may store preferences and/or any other information disclosed herein on a hard drive or any other local memory device. Accordingly, user interface 121, TMC interface 131, and/or TAP interface 141 may each retrieve and store recipient information within a memory structure of the respective interface in the form of browser cookies, for example. In another embodiment, User interface 121, TMC interface 131, and/or TAP interface 141 may each retrieve information relating to user 120, TMC 130, and/or TAP 140 from TMS 110 upon establishing a session with TMS 110. Moreover, as discussed above, user interface 121, TMC interface 131, and/or TAP interface 141 may each be embodied in a single customizable portal that loads the preferences for each of user 120, TMC 130, and/or TAP 140 based on the entity accessing TMS 110.

In an embodiment, and with momentary reference to FIG. 1B, TMS 110 may be at least partially accessible through a mobile device 122. Mobile device 122 may be any mobile device which is at least intermittently connectable to a network and configured to run a customizable micro-application (hereinafter “micro-app”). Mobile device 122 may be a smart-phone, including for example a mobile telephone configured with a Palm mobile operating system, a Windows mobile operating system, an Android Operating System, Apple iOS, a Blackberry operating system and the like, a tablet PC, including for example an iPad, a portable electronic device, including for example a PDA, an iPod Touch, and the like, or any other suitable mobile device.

In an embodiment, mobile device 122 may be configured with user interface 121. User interface 121 may take the form of a micro-app or any other suitable interface. User interface 121 may be configured to display and interact with various attributes which reside within TMS 110. The attributes may include for example, view and reconcile module 111, issue resolution engine 112, administration module 113, integration module 114, database 115 and/or other systems.

In an embodiment and with momentary reference to FIG. 1A, view and reconcile module 111 may be any software or hardware-software system configured to manage transaction data. View and reconcile module 111 may be in communication with issue resolution engine 112, administration module 113, integration module 114, database 115 and/or other systems. View and reconcile module 111 may be configured to transmit, receive, modify, supplement, tag, sort, filter, parse, and/or display transaction data. The transaction data may be associated with one or more accounts. In an embodiment, the transaction data may comprise transaction data for a common account. The transaction data may reflect transactions and/or charges for travel related expenses. The transactions and charges may be generated by multiple travelers.

View and reconcile module 111 may be configured with, coupled to or otherwise comprise user interface 121, TMC interface 131, and/or TAP interface 141. User interface 121, TMC interface 131, and/or TAP interface 141 may each be configured to display transaction data from view and reconcile module 111 to a user 120, TMC 130 and/or TAP 140 respectively. User interface 121, TMC interface 131, and/or TAP interface 141 may be customizable. For example, user interface 121 may present data in any fashion, including for example, in columns or rows that a movable by the user. Each of the columns or rows may be configured with various sorting and/or filtering functions. These sorting and/or filtering functions may be configured to allow the user to quickly and efficiently identify particular transactions based on a selected sorting feature or filter.

View and reconcile module 111 may be configured to associate a record of transaction with the associated transaction or charge that is posted to the common transaction account. View and reconcile engine 115 may also be configured to provide communication capabilities. The communication capabilities facilitate communication between user 120, TMC 130 and/or TAP 140.

In an embodiment, issue resolution engine 112 may be any software or hardware-software system configured to analyze and communicate requests for resolution. Issue resolution engine 112 may be further configured to transmit, receive, modify, supplement, tag, sort, filter, parse, and/or display transaction data and requests for resolution. The transaction data and/or requests for resolution may be associated with one or more accounts. The transaction data may reflect transactions and/or charges for travel related expenses. Issue resolution engine 112 may be configured to analyze various requests for resolution from the user. Issue resolution engine 112 may be configured to route the requests to at least one of TMC 130 and TAP 140 based on the analysis.

In an embodiment, administration module 113 may be any software or hardware-software system configured to analyze and monitor requests for resolution. Administration module 113 may be further configured to transmit, receive, modify, supplement, tag, sort, filter, parse, and/or display transaction data and requests for resolution. The requests for resolution and/or transaction data may be associated with one or more accounts and/or transactions. Administration module 113 may be configured to monitor the status of the response or overall resolution of the request for resolution by TMC 130 and/or TAP 140. Administration module 113 may also be configured to provide user 120 with updates regarding the request for resolution generated by user 120.

In an embodiment, integration module 114 may be any software or hardware-software system configured to analyze and monitor transaction data and/or resolutions. Integration module 114 may be further configured to transmit, receive, modify, supplement, tag, sort, filter, parse, and/or display transaction data and resolutions. The resolutions and/or transaction data may be associated with one or more accounts and/or transactions. Integration engine 114 may be configured to update or otherwise provide supplemental information to a transaction based on the resolution. Moreover, integration module 114 may be configured to notify user 120 of a resolution and the resulting action based on the resolution.

In an embodiment, travel information database 115, may be any software or hardware-software system configured to transmit, receive, and store transaction data, requests for resolutions, and/or resolutions. Travel information database 115 may be further configured to transmit, receive, modify, store, supplement, tag, sort, filter, parse, and/or display transaction data, user data, access data, organization data, payment data, invoice data, resolutions, and the like. Travel information database 115 may be configured to communicate any of this stored data to one or more of view and reconcile module 111, issue resolution engine 112, administration module 113, integration module 114, database 115 and/or other systems

TMS 110 may be in communication with TMC 130, TAP 140, and invoice system 150. In an embodiment, TAP 140 may be a transaction account provider as discussed above. In an embodiment, TAP 140 may comprise TAP customer service 145. TAP customer service 145 may be any software or hardware-software system configured to facilitate communication between user 120 and TAP 140. TAP customer service 145 may also be configured to facilitate transaction resolutions.

TAP 140 may be configured to provide transaction data 142 to TMS 110 and may be configured to receive transaction data 143 from TMS 110. Transaction data 142 may include authorized pending transactions and/or charges that have not been paid or otherwise satisfied. This transaction data may be stored in transaction information database 115 and may be reviewed, analyzed, monitored, and modified by TMS 110. Transaction data 143 may include authorized pending transactions and/or charges that have been selected and/or modified in TMS 110.

Invoice system 150 may be any software or hardware-software system configured to provide information to TMS 110. In an embodiment, invoice system 150 may be configured to provide transaction records (e.g. invoices, receipts, and the like) to TMS 110. Invoice system 150 may be in communication with TMC 130 and/or TAP 140.

In an embodiment and with reference to FIG. 1C, system 100 may comprise one or more internet servers 108 and one or more firewalls 109, which may each be configured to facilitate access to each of user 120, TMC 130 and/or TAP 140 through user interface 121, TMC interface 131, and/or TAP interface 141 respectively. Moreover, TMS 110 may further comprise TMS middleware 116. TMS middleware 116 may be in communication with each of the one or more internet servers 108 and one or more firewalls 109 and may be configured to compile and transfer information to TMS 110 from each of user 120, TMC 130 and/or TAP 140.

Firewall 109, as used herein, may comprise any hardware and/or software suitably configured to protect TMS 110 components from users of other networks. Firewall 109 may reside in varying configurations including stateful inspection, proxy based and packet filtering among others. Firewall 109 may be integrated as software within Internet server 108, any other TMS 110 components or may reside within another computing device or may take the form of a standalone hardware component.

Internet server 108 may include any hardware and/or software suitably configured to facilitate communications between user interface 121 and one or more TMS 110 components. Further, Internet server 108 may be configured to transmit data to user interface 121 within markup language documents. As used herein, “data” may include encompassing information such as commands, queries, files, data for storage, and/or the like in digital or any other form. Internet server 108 may operate as a single entity in a single geographic location or as separate computing components located together or in separate geographic locations.

Internet server 108 may provide a suitable web site or other Internet-based graphical user interface which is accessible by recipients. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, InterBase, etc., may be used to provide an Active Data Object (ADO) compliant database management system.

TMS 110 or any other components discussed herein may further include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases.

TMS middleware 116 may include any hardware and/or software suitably configured to facilitate communications and/or process transactions between disparate computing systems. TMS program middleware server and/or application 116 may serve as an intermediary between the various systems to ensure appropriate communications between disparate platforms. Middleware components are commercially available and known in the art. TMS middleware 116 may be implemented through commercially available hardware and/or software, through custom hardware and/or software components, or through a combination thereof TMS middleware 116 may reside in a variety of configurations and may exist as a standalone system or may be a software component residing on the Internet server 108. TMS middleware 116 may be configured to process transactions between the various components of TMS 110 and TAP 140 and any number of internal or external systems 100 for the purposes disclosed herein.

As will be appreciated by one of ordinary skill in the art, one or more of the components of system 100 may be embodied as a customization of an existing system, an add-on product, upgraded software, a stand alone system (e.g., kiosk), a distributed system, a method, a data processing system, a device for data processing, a computer and/or a computer program product. Accordingly, individual system 100 components may take the form of an entirely software embodiment, an entirely hardware embodiment, or an embodiment combining aspects of both software and hardware. In one embodiment, a system 100 component (e.g. a computer) may include a processor, a memory, a communications interface, a network interface, etc. Furthermore, individual system 100 components may take the form of a computer program product on a computer-readable storage medium having computer-readable program code means embodied in the storage medium. Any suitable computer-readable storage medium may be utilized, including hard disks, CD-ROM, flash memory, optical storage devices, magnetic storage devices, and/or the like. In one embodiment, a system 100 component and/or subsystem comprises a network interface communicating with a memory, the memory communicating with a processor; and the processor, when executing a computer program, configured to accomplish a variety of functions and/or steps.

The system discussed herein contemplates uses in association with web services, utility computing, pervasive and individualized computing, security and identity solutions, autonomic computing, commodity computing, mobility and wireless solutions, open source, biometrics, grid computing and/or mesh computing.

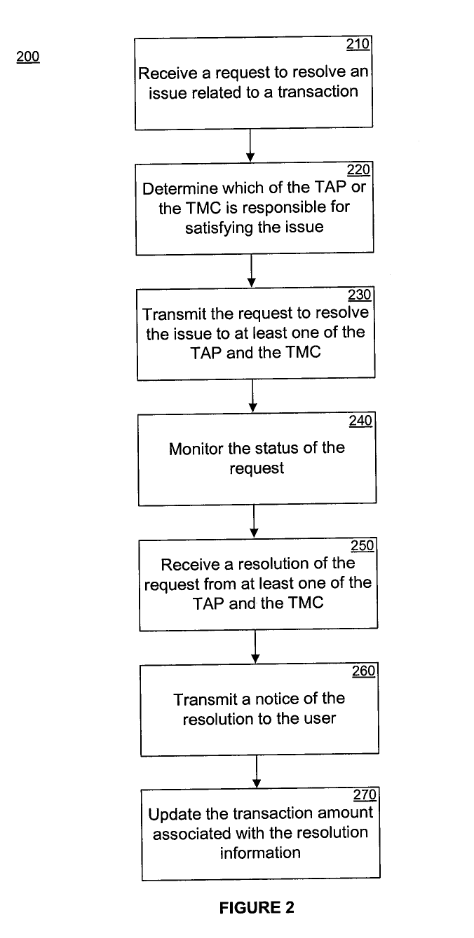

In an embodiment, and with reference to FIG. 1A and FIG. 2, method 200 for managing travel transactions is provided. Method 200 may be performed using the various hardware and software components in system 100 as described above. In an embodiment, system 100 may be configured to receive a request to resolve an issue related to a charge (Step 210). This request may originate from any one of user 120, TMC 130, and/or TAP 140. For example, user 120 may identify one of more transactions that require resolution. User 120 may then create a request to resolve the issue associated with the transaction at view and reconcile module 111. User 120 may also provide comments or an explanation of the issue associated with the charge. The request may comprise an issue identifier, a transaction account code, transaction data, and a record of the transaction. User 120 may submit the request to TMS 110.

Upon receipt of the request, TMS 110 may determine which of the TAP or the TMC is responsible for satisfying the request. TMS 110 may analyze the substance of the request to make the determination with issue resolution engine 112. For example, TMS 110 may evaluate the issue identifier. The issue identifier may be linked or otherwise identify the nature of the issue (e.g. a particular predetermined issue identifier is associated with a particular common issue). TMS may also parse and analyze the comments or explanation provided by the user. Based on this analysis (e.g. identification or expected key words), TMS 110 may determine which of the TAP or the TMC should receive the request.

Issue resolution engine 112 of TMS 110 may transmit the request to resolve the issue to at least one of the TAP and the TMC (step 230) based on the determination that at least one of the TAP and the TMC are responsible for stratifying the request. The request may comprise an issue identifier, a transaction account code, transaction data, a record of the transaction, and/or the user supplied explanation or comments. Moreover, both the TAP and the TMC is the request for resolution where both the TAP and the TMC are responsible for resolving the issue or where the user request contains multiple issues for resolution by both the TAP and the TMC. In an embodiment, the TAP may receive every (or many) request for resolution, whether or not the TAP is responsible for the request. This may provide a notification to the TAP that a particular transaction is currently being investigated and will not be paid during the investigation.

TMS 110 may be configured to monitor the status of the request (Step 240). Administration module 113 may be configured to grade or analyze the progress of a particular request. For example, TMS 110 may comprise a predetermined set of rules that govern how issues are resolved (e.g. time period or responding, total time for request to resolution, and the like). The predetermined rules may provide a prediction of the resolution timeline to the customers. The predetermined rules may also provide the TAP with a mechanism to evaluate the performance of a particular TMC. Typically, there is a contractual relationship that provides the TMC with a benefit (e.g. access to TAP customers) and includes that the TMC provide a predetermined level of service. As such, the grading by administration module 113 allows the TAP to quantitatively evaluate the actual service of a TMC against the predetermined level of service specified by the TAP. The performance of a particular TMC may be evaluated on an individual request for resolution basis, over a period of time based on multiple requests for resolution, or in any other fashion suitable for evaluating the performance of the TMC.

TMS 110 may present the evaluation of each TMC to the user and/or the TAP. The evaluation may be present in any suitable fashion. For example, the evaluation may be presented as a percentage of the requests for resolution satisfactorily resolved in the predetermined period of time. The evaluation may also be presented graphically (e.g. a pie chart showing the number of requests for resolution resolved with a predetermined period of time and the number of requests for resolution resolved outside of a predetermined period of time).

TMS 110 may receive a resolution of the request from at least one of the TAP and the TMC (Step 250). Integration engine 114 may be configured to receive and analyze the resolution provided by TAP and/or TMC. Transaction data may be modified where the resolution requires a change to the transaction associated with the request for resolution. TMS 110 may also be configured to transmit a notice of the resolution to the user (Step 260). The notice may be an communication (e.g. an e-mail) or a status change of the status of the transaction associated with the request for resolution (e.g. the transaction status is changed from under review to resolved).

TMS 110 may be configured to update the transaction amount associated with the resolution information (Step 270). For example, where the request for resolution contained a request to adjust the amount of a charge, the transaction data may be modified such that the amount due complies with the resolution information. The modification of the transaction may also require that the user pay or otherwise satisfy the transaction. TMS 110 may also store the requests for resolution and associated resolution information. The stored information may be accessible by at least one of user 120, TMC 130, and TAP 140. The stored information may also be associated with a particular account or transaction.

A travel management system for use in a telecommunications network may also interface with the embodiments herein. In particular, such a system includes a user interface configured to communicate over a telecommunication network, a telecommunication service provider configured to facilitate a connection to the telecommunication network, a travel management system, a transaction account provider, a travel management company, and a communication network providing communication between the user, the travel management system, the travel management company, and the transaction account provider. The travel management system includes a travel management system configured to track transactions and requests for resolution, modify transaction data based on resolution information, and facilitate payment of transactions and a transaction management system middleware which facilitates communication of the travel management system with a user, a travel management company and a transaction account provider such that transactions and requests for resolution can be satisfied.

A travel management system for a peer-to-peer transaction may also interface with the embodiments herein. In particular, such a system includes first and second personal communication devices configured to participate in a peer-to-peer transaction, a travel management system, and a communication network providing two-way communication between one of said personal communication devices and the travel management system. The travel management system includes a travel management system configured to track transactions and requests for resolution, modify transaction data based on resolution information, and facilitate payment of transactions and a transaction management system middleware which facilitates communication of the travel management system with a user, a travel management company and a transaction account provider such that transactions and requests for resolution can be satisfied.

Any of the communications, inputs, storage, databases or displays discussed herein may be facilitated through a web site having web pages. The term “web page” as it is used herein is not meant to limit the type of documents and applications that might be used to interact with the user. For example, a typical web site might include, in addition to standard HTML documents, various forms, Java applets, JavaScript, active server pages (ASP), common gateway interface scripts (CGI), extensible markup language (XML), dynamic HTML, cascading style sheets (CSS), helper applications, plug-ins, and/or the like. A server may include a web service that receives a request from a web server, the request including a URL (e.g. http://yahoo.com/stockquotes/ge) and an IP address (e.g. 123.4.56.789). The web server retrieves the appropriate web pages and sends the data or applications for the web pages to the IP address. Web services are applications that are capable of interacting with other applications over a communications means, such as the Internet. Web services are typically based on standards or protocols such as XML, SOAP, WSDL and UDDI. Web services methods are well known in the art, and are covered in many standard texts. See, e.g., Alex Nghiem, IT Web Services: A Roadmap for the Enterprise (2003), hereby incorporated by reference.

In order to control access to any component of TMS 110, Internet server 108 may invoke an authentication server (not shown) in response to user 120 submissions of authentication credentials received at Internet server 108 from user interface 121. The authentication server may include any hardware and/or software suitably configured to receive authentication credentials, encrypt and decrypt credentials, authenticate credentials, and grant access rights according to privileges (e.g., pre-defined privileges) attached to the credentials. The authentication server may grant varying degrees of application and data level access to users based on information stored within a database and/or any other known memory structure.

One skilled in the art will appreciate that system 100 may employ any number of databases in any number of configurations. Further, any databases discussed herein may be any type of database, such as relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of system 100, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with system 100 by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments of system 100, the data can be stored without regard to a common format. However, in one exemplary embodiment, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand-alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand-alone device, the appropriate option for the action to be taken. System 100 contemplates a data storage arrangement wherein the header or trailer, or header or trailer history, of the data is stored on the transaction instrument in relation to the appropriate data.

One skilled in the art will also appreciate that, for security reasons, any databases, systems, devices, servers or other components of system 100 may consist of any combination thereof at a single location or at multiple locations, wherein each database or system 100 includes any of various suitable security features, such as firewalls, access codes, encryption, decryption, compression, decompression, and/or the like.

In addition to those described above, the various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the present invention. As those skilled in the art will appreciate, user computer may include an operating system (e.g., Windows NT, 95/98/2000, OS2, UNIX, Linux, Solaris, MacOS, etc.) as well as various conventional support software and drivers typically associated with computers. The computer may include any suitable personal computer, network computer, workstation, minicomputer, mainframe or the like. User computer can be in a home or business environment with access to a network. In an exemplary embodiment, access is through a network or the Internet through a commercially-available web-browser software package.

As used herein, the term “network” shall include any communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, satellite communications, off-line communications, wireless communications, transponder communications, local area network (LAN), wide area network (WAN), networked or linked devices, keyboard, mouse and/or any suitable communication or data input modality. Moreover, although the invention is frequently described herein as being implemented with TCP/IP communications protocols, the invention may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, Dilip Naik, Internet Standards And Protocols (1998); Java 2 Complete, various authors, (Sybex 1999); Deborah Ray And Eric Ray, Mastering Html 4.0 (1997); and Loshin, TCP/IP Clearly Explained (1997) and David Gourley and Brian Totty, HTTP, The Definitive Guide (2002), the contents of which are hereby incorporated by reference.

In an embodiment, various components, modules, and/or engines of system 100 may be implemented as micro-applications or micro-apps. Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

The invention may be described herein in terms of functional block components, screen shots, optional selections and various processing steps. It should be appreciated that such functional blocks may be realized by any number of hardware and/or software components configured to perform the specified functions. For example, system 100 may employ various integrated circuit components, e.g., memory elements, processing elements, logic elements, look-up tables, and/or the like, which may carry out a variety of functions under the control of one or more microprocessors or other control devices. Similarly, the software elements of system 100 may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that system 100 may employ any number of conventional techniques for data transmission, signaling, data processing, network control, and/or the like. Still further, system 100 could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, may be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Practitioners will appreciate that the illustrated steps described herein may comprise in any number of configurations including the use of windows, web pages, web forms, popup windows, prompts and/or the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

Practitioners will appreciate that there are a number of methods for displaying data within a browser-based document. Data may be represented as standard text or within a fixed list, scrollable list, drop-down list, editable text field, fixed text field, pop-up window, and/or the like. Likewise, there are a number of methods available for modifying data in a web page such as, for example, free text entry using a keyboard, selection of menu items, check boxes, option boxes, and/or the like.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the invention. The scope of the invention is accordingly to be limited by nothing other than the appended claims, in which reference to an element in the singular is not intended to mean “one and only one” unless explicitly so stated, but rather “one or more.” Moreover, where a phrase similar to ‘at least one of A, B, or C’ or ‘at least one of A, B, and C’ are used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. All structural, chemical, and functional equivalents to the elements of the above-described exemplary embodiments that are known to those of ordinary skill in the art are expressly incorporated herein by reference and are intended to be encompassed by the present claims. Further, a list of elements does not include only those elements but may include other elements not expressly listed or inherent to such process, method, article, or apparatus.

We claim:

1. A method comprising:
receiving, by a computer based system for managing a transactions, a request to resolve an issue related to a transaction;
determining, by the computer based system, which of the transaction account provider and the travel management company is responsible for satisfying the issue;
transmitting, by the computer based system, the request to resolve the issue to at least one of the transaction account provider and the travel management company;
receiving, by the computer based system, resolution information associated with the request from at least one of the transaction account provide and the travel management company; and
updating, by the computer based system, a transaction amount associated with the resolution information.

2. The method of claim 1, further comprising transmitting, by the computer based system, a notice of resolution to a user.

3. The method of claim 1, further comprising, determining, by the computer based system, a rating of at least one of the transaction account provider and the travel management company based on the request.

4. The method of claim 1, further comprising monitoring, by the computer based system, the status of the request, wherein the status of the request is evaluated against a set of predetermined rules.

5. The method of claim 4, wherein the predetermined rules comprise at least one of a time to respond and a total time of pendency prior to the resolution information being received.

6. The method of claim 1, wherein the transaction is associated with a common transaction account.

7. The method of claim 6, wherein the common transaction account receives transactions for various travelers.

8. The method of claim 1, wherein the request to resolve the issue is provided via a user interface.

9. The method of claim 8, wherein the user interface is provided through a micro-application on a mobile device.

10. The method of claim 1, further comprising receiving, by the computer based system, comments associated with the request to resolve the issue.

11. The method of claim 1, wherein the transaction account provider receives the request to resolve the issue related to the transaction.

12. The method of claim 1, further comprising monitoring, by the computer based system, the status of the request, wherein the status of the transaction is changed in response to the request to resolve the issue.

13. The method of claim 12, wherein a payment deadline associated with the transaction is suspended in response to the status being changed.

14. The method of claim 13, further comprising, receiving, by the computer based system, resolution information, wherein the payment deadline associated with the transaction is re-established in response to the resolution information.

15. The method of claim 1, further comprising associating, by the computer based system, a record of transaction with the transaction.

16. The method of claim 15, wherein the record of transaction is provided with the request to resolve the issue.

17. The method of claim 1, wherein the request to resolve the issue comprises an issue identifier.

18. The method of claim 17, wherein the responsibility of the satisfying the issue is determined based at least in part on the issue identifier.

19. A non-transitory, tangible computer-readable storage medium having computer-executable instructions stored thereon that, if executed by a computer based system for managing a transactions, cause the computer based system to perform operations comprising:
receiving, by the computer based system, a request to resolve an issue related to a transaction;
determining, by the computer based system, which of the transaction account provider and the travel management company is responsible for satisfying the issue;
transmitting, by the computer based system, the request to resolve the issue to at least one of the transaction account provider and the travel management company;
receiving, by the computer based system, resolution information associated with the request from at least one of the transaction account provide and the travel management company; and
updating, by the computer based system, a transaction amount associated with the resolution information.

20. A computer based system for managing a transactions comprising:
a network interface communicating with a non-transitory memory;
the memory communicating with a processor; and
the processor, when executing a computer program, is configured to:
receive a request to resolve an issue related to a transaction;
determine which of the transaction account provider and the travel management company is responsible for satisfying the issue;
transmit the request to resolve the issue to at least one of the transaction account provider and the travel management company;
receive resolution information associated with the request from at least one of the transaction account provide and the travel management company; and
update a transaction amount associated with the resolution information.
